(19) United States
(12) Patent Application Publication
(10) Pub. No.: US 2024/0162499 A1
(43) Pub. Date: May 16, 2024

(54) METHOD FOR MANUFACTURING LITHIUM-ION RECHARGEABLE BATTERY AND LITHIUM-ION RECHARGEABLE BATTERY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventors: Masumi TANIMOTO, Toyota-shi (JP); Shotaro DEGUCHI, Toyohashi-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/388,585

(22) Filed: Nov. 10, 2023

(30) Foreign Application Priority Data
Nov. 15, 2022 (JP) 2022-182245

(51) Int. Cl. H01M 10/0587; H01M 4/04; H01M 4/36; H01M 10/0525; H01M 10/0568

(52) U.S. Cl. CPC H01M 10/0587; H01M 4/0416; H01M 4/364; H01M 10/0525; H01M 10/0568; H01M 2300/0051

(57) ABSTRACT

A method for manufacturing a lithium-ion rechargeable battery includes manufacturing a positive electrode plate that includes a positive electrode mixture layer containing a positive electrode active material, lithium hydroxide, and lithium acetate; manufacturing a negative electrode plate that includes a negative electrode mixture layer containing a negative electrode active material and a sodium salt; and injecting a non-aqueous electrolyte solution including LiBOB into a case that accommodates the positive and negative plates. When “A” represents a mole number of the lithium hydroxide added in the manufacturing the positive electrode plate, “B” represents a mole number of the lithium acetate formed in the manufacturing the positive electrode plate, and “C” represents a mole number of the sodium salt added in the manufacturing the negative electrode plate, 0.04≤B/A≤0.06 and 1.9≤B/C are satisfied. Lithium acetate has a higher solubility in the non-aqueous electrolyte solution than sodium acetate.

### BACKGROUND

### 1. Field

The following description relates to a lithium-ion rechargeable battery that uses a non-aqueous electrolyte solution including lithium bis(oxalate) borate (LiBOB) and a method for manufacturing the lithium-ion rechargeable battery.

### 2. Description of Related Art

In a lithium-ion rechargeable battery, a solid electrolyte interface (SEI) film forms on the surface of a negative electrode mixture layer. The SEI film captures lithium ions as the SEI film forms. As the SEI film increases in thickness due to repetitive charging and discharging or long-term storage of the battery, the lithium ions used in charging and discharging decreases and reduces the battery capacity.

To solve such problem, a known technique adds lithium bis(oxalate) borate (LiBOB, Lib(C₂O₄)₂) to a non-aqueous electrolyte solution. LiBOB is added to the non-aqueous electrolyte solution to apply a stable coating derived from bis(oxalate) borate ions (BOB ions, B(C₂O₄)2⁻), which are ionized from LiBOB, to the surfaces of negative electrode active material particles. This limits the growth of the SEI film (refer to Japanese Laid-Open Patent Publication No. 2013-225440).

### SUMMARY

However, the BOB ions ionized from LiBOB react with the sodium ions in the negative electrode mixture layer, and form a NaBOB film on the surface of the negative electrode mixture layer. The sodium ions are derived from, for example, carboxymethyl cellulose (CMC), which is used as a dispersant and a viscosity increasing agent in the negative electrode mixture layer. The NaBOB film increases the resistance of the negative electrode mixture layer. Thus, it is desirable that the formation of such NaBOB film be limited.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method for manufacturing a lithium-ion rechargeable battery includes manufacturing a positive electrode plate by forming a positive electrode mixture layer on a positive electrode substrate, manufacturing a negative electrode plate by forming a negative electrode mixture layer on a negative electrode substrate, and injecting a non-aqueous electrolyte solution including LiBOB into a case that accommodates an electrode body including the positive electrode plate and the negative electrode plate. The positive electrode mixture layer uses a positive electrode mixture paste as a precursor. An organic acid and a positive electrode active material including lithium hydroxide are added to the positive electrode mixture paste. The negative electrode mixture layer uses a negative electrode mixture layer as a precursor. A sodium salt is added to the negative electrode mixture paste. The manufacturing the positive electrode plate includes forming a first organic acid salt in the positive electrode mixture layer. The first organic acid salt is formed from lithium ions derived from the lithium hydroxide and organic acid ions derived from the organic acid. When “A” represents a mole number of the lithium hydroxide added in the manufacturing the positive electrode plate, “B” represents a mole number of the first organic acid salt formed in the manufacturing the positive electrode plate, and “C” represents a mole number of the sodium salt added in the manufacturing the negative electrode plate, values A, B, and C satisfy 0.04≤B/A≤0.06 and 1.9≤B/C. The first organic acid salt has a higher solubility in the non-aqueous electrolyte solution than a second organic acid salt, formed from sodium ions and organic acid ions of the same type as that forming the first organic acid salt.

The BOB ions ionized from LiBOB in the non-aqueous electrolyte solution have a lower diffuse rate than the other components in the non-aqueous electrolyte solution. Thus, immediately after the non-aqueous electrolyte solution is injected, the second organic acid salt is formed by reaction of the sodium ions, ionized from the sodium salt included in the negative electrode mixture layer, and the organic acid ions, ionized from the first organic acid salt included in the positive electrode mixture layer. In this case, since the first organic acid salt has a higher solubility in the non-aqueous electrolyte solution than the second organic acid salt, the second organic acid salt deposits more easily than the first organic acid salt. As a result, when the BOB ions impregnate the electrode body later than the other components in the non-aqueous electrolyte solution, the number of sodium ions in the non-aqueous electrolyte solution is small. This limits formation of a NaBOB film caused by reaction of sodium ions and BOB ions. In this case, the ratio of the mole number of first organic acid salt in the positive electrode mixture layer to the mole number of sodium salt added to the negative electrode mixture layer, or B/C, satisfies 1.9≤B/C. This appropriately decreases the number of sodium ions in the non-aqueous electrolyte solution and restricts an increase in the resistance resulting from formation of a NaBOB film.

Further, in the positive electrode mixture paste, lithium hydroxide is partly neutralized by the organic acid. When the content ratio of lithium hydroxide in the positive electrode mixture paste is overly high, gelation of the positive electrode mixture paste is likely to occur. When the content ratio of acetic acid is overly high, the thixotropy of the positive electrode mixture paste is lost thereby causing the components of the positive electrode mixture paste to precipitate easily. In such case, the bonding between the positive electrode mixture layer and the positive electrode plate may become deficient. Thus, the amount of added organic acid needs to be controlled to avoid both gelation of the positive electrode mixture paste and precipitation of the components in the positive electrode mixture paste in a state in which the lithium hydroxide is partly neutralized by the organic acid. Value B/A corresponds to the ratio of the mole number of the organic acid ions that neutralize lithium hydroxide to the mole number of the lithium hydroxide added to the positive electrode mixture paste. Thus, when 0.04≤B/A≤0.06 is satisfied, both gelation of the positive electrode mixture paste and precipitation of the components in the positive electrode mixture paste are avoided even in a state in which the lithium hydroxide is partly neutralized by the organic acid.

In the above method, the organic acid is acetic acid or acetic anhydride.

The acetic acid or acetic anhydride is used as the organic acid, so that the first organic acid salt is lithium acetate and the second organic acid salt is sodium acetate. In this case, the first organic acid salt has a higher solubility in the non-aqueous electrolyte solution than the second organic acid salt.

In the above method, the injecting the non-aqueous electrolyte solution includes injecting the non-aqueous electrolyte solution set in a range of 10° C. to 20° C., inclusive.

The temperature of the non-aqueous electrolyte solution injected into the case is set to be lower than or equal to 20° C. to further decrease the solubility of the second organic acid salt in the non-aqueous electrolyte solution. This facilitates deposition of the second organic acid salt. As a result, the concentration of sodium ions in the non-aqueous electrolyte solution is further lowered, and formation of a NaBOB film is limited. Also, the temperature of the non-aqueous electrolyte solution injected into the case is set to be higher than or equal to 10° C. to avoid an excessive decrease in the fluidity of the non-aqueous electrolyte solution. This avoids uneven impregnation of the electrode body with the non-aqueous electrolyte solution.

In the above method, the non-aqueous electrolyte solution includes ethylene carbonate, dimethyl carbonate, and ethyl methyl carbonate.

If ethylene carbonate is used as the only solvent of the non-aqueous electrolyte solution, and the temperature of the non-aqueous electrolyte solution is set in a range of 10° C. to 20° C., inclusive, the fluidity of the non-aqueous electrolyte solution may become overly low because ethylene carbonate has a high melting temperature. In this regard, the non-aqueous electrolyte solution uses a mixture of ethylene carbonate, dimethyl carbonate, and ethyl methyl carbonate to maintain an appropriate fluidity of the non-aqueous electrolyte solution even when the temperature of the non-aqueous electrolyte solution is set in a range of 10° C. to 20° C., inclusive.

In another general aspect, a lithium-ion rechargeable battery includes an electrode body including a positive electrode plate and a negative electrode plate, a non-aqueous electrolyte solution including LiBOB, lithium hydroxide included in the positive electrode plate, an organic acid component, and a sodium component. The organic acid component includes at least one of a first organic acid salt, formed from organic acid ions and sodium ions, and organic acid ions ionized from the first organic acid salt, and a second organic acid formed from sodium ions and organic acid ions ionized from the first organic acid salt. The sodium component includes the second organic acid salt or a combination of the second organic acid salt and at least one of sodium salt included in the negative electrode plate, and sodium ions ionized from the sodium salt. When “A” represents a sum of a mole number of the lithium hydroxide and a mole number of the organic acid component, “B” represents a mole number of the organic acid component, and “C” represents a mole number of the sodium component, values A, B, and C satisfy 0.04≤B/A≤0.06 and 1.9≤B/C. The first organic acid salt has a higher solubility in the non-aqueous electrolyte solution than the second organic acid salt.

With the above configuration, the ratio of the mole number of organic acid component to the mole number of sodium component in the lithium-ion rechargeable battery, or value B/C, satisfies 1.9≤B/C. This appropriately decreases the number of sodium ions in the non-aqueous electrolyte solution and restricts an increase in the resistance resulting from formation of NaBOB. Further, the ratio of the mole number of organic acid component to the sum of the mole number of lithium hydroxide in the positive electrode mixture layer and the mole number of organic acid component, or value B/A, satisfies 0.04≤B/A≤0.06. This avoids both gelation of the positive electrode mixture paste and precipitation of the components in the positive electrode mixture paste.

Other features and aspects will be apparent from the following detailed description, the drawings, and the claims.

### BRIEF DESCRIPTION OF THE DRAWINGS

FIG. 1 is a perspective view of a lithium-ion rechargeable battery.

FIG. 2 is a perspective view of an electrode body in an unrolled state.

FIG. 3 is a cross-sectional view taken along line of FIG. 2.

FIG. 4 is a flowchart illustrating a manufacturing process of the lithium-ion rechargeable battery.

FIG. 5 is a schematic diagram illustrating a reaction of excess lithium and an organic acid when a positive electrode mixture paste is kneaded.

FIG. 6 is a schematic diagram illustrating a reaction of components included in a positive electrode mixture layer and components included in a negative electrode mixture layer immediately after a non-aqueous electrolyte solution is injected.

FIG. 7 is a schematic diagram illustrating a state of the components included in the positive electrode mixture layer and the negative electrode mixture layer after injection of the non-aqueous electrolyte solution and when BOB ions reach the electrode body later than other components.

FIG. 8 is a table showing values A, B, and C in examples and comparative examples, and evaluation results.

FIG. 9 is a graph showing a reaction resistance relative to value B/C of the examples and the comparative examples.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

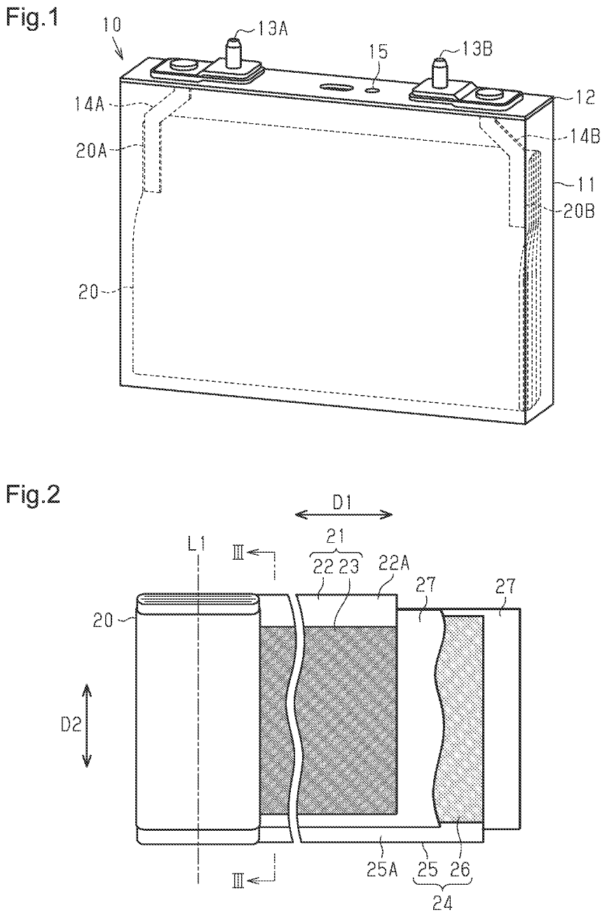

An embodiment of the present disclosure will now be described with reference to FIGS. 1 to 7.

### Lithium-Ion Rechargeable Battery

As shown in FIG. 1, a lithium-ion rechargeable battery 10 includes a case 11 and an electrode body 20. The case 11 is box-shaped and has an open upper end. The case 11 accommodates the electrode body 20 and a non-aqueous electrolyte solution. The lid 12 closes the opening of the case 11. The case 11 forms a sealed box-shaped battery container by attaching the lid 12 to the case 11.

An external terminal 13A of the positive electrode and an external terminal 13B of the negative electrode are arranged on the lid 12. A positive electrode current collector portion 20A, which is the positive end of the electrode body 20, is electrically connected by a positive electrode current collector member 14A to the positive electrode external terminal 13A. A negative electrode current collector portion 20B, which is the negative end of the electrode body 20, is electrically connected by a negative electrode current collector member 14B to the negative electrode external terminal 13B. The lid 12 includes an inlet 15 for injection of the non-aqueous electrolyte solution. The external terminals 13A and 13B do not have to be shaped as shown in FIG. 1 and may have any shape.

### Electrode Body

As shown in FIG. 2, the electrode body 20 is a flat rolled body formed by rolling a stack of a positive electrode plate 21, a negative electrode plate 24, and separators 27. The positive electrode plate 21, the negative electrode plate 24, and the separators 27 are stacked so that their long sides are parallel to a longitudinal direction D1. The electrode body 20 is structured by rolling the stack of the positive electrode plate 21 and the negative electrode plate 24 with the separators 27 held in between about a rolling axis L1 that extends in a widthwise direction D2 of the strips.

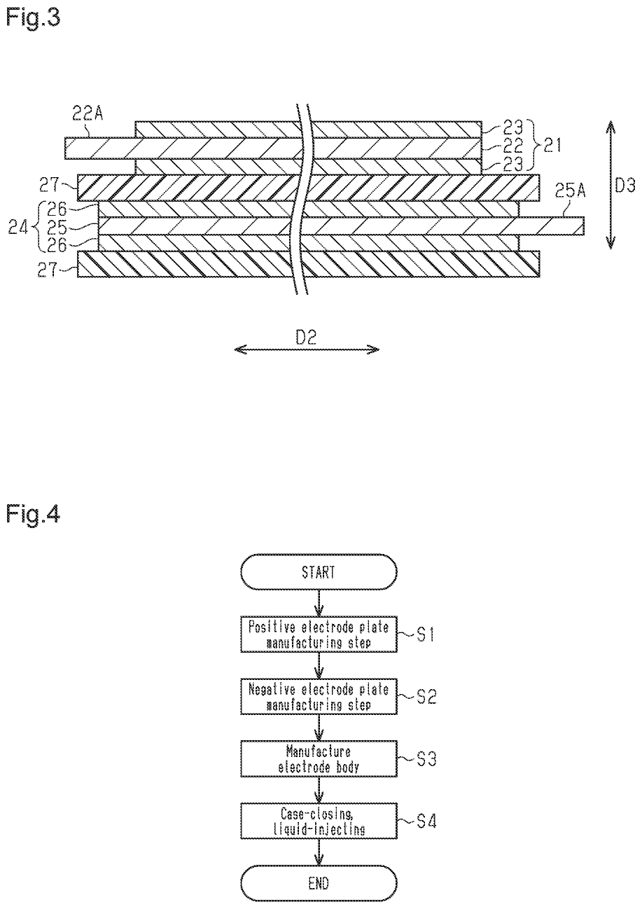

As shown in FIG. 3, in the electrode body 20, the positive electrode plate 21, the separator 27, the negative electrode plate 24, and the separator 27 are stacked in this order in a stacking direction D3. The stacking direction D3 is orthogonal to a plane along which the longitudinal direction D1 and the widthwise direction D2 extend.

### Positive Electrode Plate

The positive electrode plate 21 includes a positive electrode substrate 22 and a positive electrode mixture layer 23. The positive electrode substrate 22 is a foil of a metal such as aluminum or an alloy having aluminum as a main component. The positive electrode mixture layer 23 is applied to each of two opposite surfaces of the positive electrode substrate 22. One end of the positive electrode substrate 22 in the widthwise direction D2 includes a positive electrode uncoated portion 22A where the positive electrode mixture layer 23 is not formed and the positive electrode substrate 22 is exposed. In the roll, opposing parts in the positive electrode uncoated portion 22A of the positive electrode substrate 22 are press-bonded together to form the positive electrode current collector portion 20A.

The positive electrode mixture layer 23 includes a positive electrode active material, a positive electrode conductive agent, and a positive electrode binder. A positive electrode mixture paste, which serves as a precursor of the positive electrode mixture layer 23, further includes a positive electrode solvent. For example, the positive electrode solvent is an N-methyl-2-pyrrolidone (NMP) solvent, which is an example of an organic solvent.

The positive electrode active material is a lithium-containing composite metal oxide that allows for the storage and release of lithium ions, which serve as the charge carrier of the lithium-ion rechargeable battery 10. A lithium-containing composite metal oxide is an oxide containing lithium and a metal element other than lithium. The metal element other than lithium is, for example, one selected from a group consisting of nickel, cobalt, manganese, vanadium, magnesium, molybdenum, niobium, titanium, tungsten, aluminum, and iron contained as iron phosphate in the lithium-containing composite metal oxide. The positive electrode active material further includes excess lithium. Excessive lithium is lithium hydroxide (LiOH) that is unavoidably included in the positive electrode active material.

The lithium-containing composite metal oxide may be, for example, lithium cobalt oxide (LiCoO₂), lithium nickel oxide (LiNiO₂), or lithium manganese oxide (LiMn₂O₄). Further, the lithium-containing composite metal oxide may be, for example, a three-element lithium-containing composite metal oxide that contains nickel, cobalt, and manganese (NCM), that is, lithium nickel manganese cobalt oxide (LiNiCoMnO₂). The lithium-containing composite metal oxide is, for example, lithium iron phosphate (LiFePO₄).

The positive electrode conductive agent is, for example, carbon black such as acetylene black (AB) or ketjen black, carbon fibers such as carbon nanotubes (CNT) or carbon nanofibers, or graphite. The positive electrode binder is, for example, one selected from a group consisting of polyvinylidene fluoride (PVDF) and polyvinyl alcohol (PVA).

The positive electrode plate 21 may include an insulation layer between the positive electrode uncoated portion 22A and the positive electrode mixture layer 23. The insulation layer includes an insulative inorganic component and a resin component that functions as a binder. The inorganic material is at least one selected from a group consisting of powdered boehmite, titania, and alumina. The resin component is at least one selected from a group consisting of PVDF, PVA, and acrylic.

### Negative Electrode Plate

The negative electrode plate 24 includes a negative electrode substrate 25 and a negative electrode mixture layer 26. The negative electrode substrate 25 is a foil of a metal such as copper or an alloy having copper as a main component. The negative electrode mixture layer 26 is applied to each of two opposite surfaces of the negative electrode substrate 25. One end of the negative electrode substrate 25 in the widthwise direction D2 at the side opposite the positive electrode uncoated portion 22A includes a negative electrode uncoated portion 25A where the negative electrode mixture layer 26 is not formed and the negative electrode substrate 25 is exposed. In the roll, opposing parts in the negative electrode uncoated portion 25A are pressed-bonded together to form the negative electrode current collector portion 20B.

The negative electrode mixture layer 26 includes a negative electrode active material, a negative electrode conductive agent, a negative electrode viscosity increasing agent, and a negative electrode binder. Further, a negative electrode mixture paste, which serves as a precursor of the negative electrode mixture layer 26, includes a negative electrode solvent. An example of the negative electrode solvent is water.

The negative electrode active material allows for the storage and release of lithium ions. The negative electrode active material is, for example, a carbon material such as graphite, hard carbon, soft carbon, or carbon nanotubes. The negative electrode active material may be composite particles in which graphite particles are coated with an amorphous carbon layer.

The negative electrode conductive agent may be the same material as the positive electrode conductive agent. An example of the negative electrode viscosity increasing agent may be carboxymethyl cellulose (CMC). CMC is an example of an additive including sodium salt. The CMC also serves as a dispersant that disperses the negative electrode active material in the negative electrode mixture paste. The negative electrode binder is, for example, at least one selected from a group consisting of PVDF, PVA, styrene-butadiene rubber (SBR), and styrene-acrylic acid resin. A component of the negative electrode binder including sodium salt, such as SBR, is an example of an additive that includes sodium salt.

### Separator

The separators 27 prevent contact between the positive electrode plate 21 and the negative electrode plate 24 in addition to holding the non-aqueous electrolyte solution between the positive electrode plate 21 and the negative electrode plate 24 Immersion of the electrode body 20 in the non-aqueous electrolyte solution results in the non-aqueous electrolyte solution permeating each separator 27 from the ends toward the center.

Each separator 27 is a porous nonwoven fabric of polypropylene or the like. The separator 27 may be, for example, a porous polymer film, such as a porous polyethylene film, a porous polyolefin film, or a porous polyvinyl chloride film, an ion conductive polymer electrolyte film, or the like.

### Non-Aqueous Electrolyte Solution

The non-aqueous electrolyte solution is a composition containing a supporting electrolyte in a non-aqueous solvent. The non-aqueous solvent is one or two or more selected from, for example, a group consisting of propylene carbonate, ethylene carbonate, diethyl carbonate, dimethyl carbonate, and ethyl methyl carbonate. The supporting electrolyte is a lithium compound of one or two or more selected from, for example, a group consisting of LiPF₆, LiBF₄, LiClO₄, LiAsF₆, LiCF₃SO₃, LiC₄F₉SO₃, LiN(CF₃SO₂)₂, LiC(CF₃SO₂)₃, LiI, and the like.

The non-aqueous electrolyte solution of the present embodiment includes, for example, ethylene carbonate, dimethyl carbonate, and ethyl methyl carbonate as non-aqueous solvents. Preferably, a mass ratio of ethylene carbonate, dimethyl carbonate, and ethyl methyl carbonate in the non-aqueous electrolyte solution is, for example, 1:1:1.

A film forming agent is added to the non-aqueous electrolyte solution. The film forming agent is, for example, lithium bis(oxalate) borate (LiBOB). For example, LiBOB is added to the non-aqueous electrolyte solution so that the concentration of LiBOB in the non-aqueous electrolyte solution is in a range of 0.001 mol/L to 0.1 mol/L, inclusive.

### Organic Acid Component

In addition to the above-described raw materials, an organic acid is added to the positive electrode mixture paste. The lithium-ion rechargeable battery 10 includes an organic acid component derived from the organic acid added to the positive electrode mixture paste. The organic acid component is present either as ions dissolved in the non-aqueous electrolyte solution or as an organic acid salt deposited on the electrode body 20.

An example of the organic acid component is a first organic acid salt deposited on the positive electrode mixture layer 23 as a result of neutralization reaction of the organic acid, added to the positive electrode mixture paste, and lithium hydroxide, which is the excess lithium. The organic acid is, for example, acetic acid (CH₃COOH) or acetic anhydride ((CH₃CO)₂O). In this case, the first organic acid salt is lithium acetate (CH₃COOLi). An example of the organic acid component is organic acid ions ionized from the first organic acid salt. For example, when the organic acid is acetic acid or acetic anhydride, the organic acid ions are acetic acid ions (CH₃COO⁻). An example of the organic acid component is a second organic acid salt formed from the above organic acid ions and sodium ions. For example, when the organic acid is acetic acid, the second organic acid salt is sodium acetate (CH₃COONa). The sodium ions are derived from, for example, the sodium salt included in the additive, added to the negative electrode mixture paste as the negative electrode viscosity increasing agent.

The lithium-ion rechargeable battery 10 includes, as the organic acid component, at least the second organic acid salt and at least one of the first organic acid salt and the organic acid ions. For example, when the positive electrode mixture layer 23 including the first organic acid salt comes into contact with the non-aqueous electrolyte solution, the first organic acid salt is ionized into organic acid ions. The first organic acid salt, for example, may remain without being dissolved in the positive electrode mixture layer 23 at locations where contact with the non-aqueous electrolyte solution is limited, such as in a portion of the positive electrode mixture layer 23 close to the positive electrode substrate 22. Alternatively, all of the first organic acid salt in the positive electrode mixture layer 23 may be dissolved in the non-aqueous electrolyte solution. At least some of the organic acid ions ionized from the first organic acid salt react with the sodium ions and form the second organic acid salt. When the number of organic acid ions ionized from the first organic acid salt is small, the organic acid ions may deposit as the second organic acid salt such that organic acid ions are absent from the non-aqueous electrolyte solution.

### Sodium Component

The lithium-ion rechargeable battery 10 includes a sodium component. The sodium component is present either as ions in the non-aqueous electrolyte solution or as a sodium salt deposited on the electrode body 20. An example of the sodium component is the sodium salt included in the additive, added to the negative electrode mixture paste. An example of the sodium component is sodium ions ionized from the sodium salt. An example of the sodium component is the second organic acid salt formed from the sodium ions and organic acid ions. Thus, the second organic acid salt is both the organic acid component and the sodium component.

The lithium-ion rechargeable battery 10 includes at least the second organic acid salt as the sodium component. In addition to the second organic acid salt, the lithium-ion rechargeable battery 10 may include, as the sodium component, at least one of sodium salt added to the negative electrode mixture paste and sodium ions. For example, when the negative electrode mixture layer 26 including the sodium salt comes into contact with the non-aqueous electrolyte solution, the sodium salt is ionized into sodium ions. The sodium salt may remain without being dissolved in the negative electrode mixture layer 26 at locations where contact with the non-aqueous electrolyte solution is limited, such as in a portion of the negative electrode mixture layer 26 close to the negative electrode substrate 25. Alternatively, all of the sodium salt in the negative electrode mixture layer 26 may be dissolved in the non-aqueous electrolyte solution. At least some of the sodium ions ionized from the sodium salt react with the acetic acid ions and form the second organic acid salt. All of the sodium ions ionized from the sodium salt may deposit as the second organic acid salt such that sodium ions are absent from the non-aqueous electrolyte solution. Alternatively, when the number of organic acid ions ionized from the first organic acid salt is locally small, sodium ions may be present in the non-aqueous electrolyte solution.

### Method for Manufacturing Lithium-Ion Rechargeable Battery

As shown in FIG. 4, a method for manufacturing the lithium-ion rechargeable battery 10 includes steps S1 to S4. In step S1, the positive electrode plate 21 is manufactured. The positive electrode plate manufacturing step of step S1 includes a step of preparing a positive electrode mixture paste by kneading the raw materials of the positive electrode mixture paste, and a step of forming the positive electrode mixture layer 23 by applying the positive electrode mixture paste to the positive electrode substrate 22, drying the applied positive electrode mixture paste, and pressing the dried positive electrode mixture paste to an appropriate thickness. The positive electrode plate 21 is manufactured through these steps.

In step S2, the negative electrode plate 24 is manufactured. The negative electrode plate manufacturing step of step S2 includes a step of preparing a negative electrode mixture paste by kneading the raw materials of the negative electrode mixture paste, and a step of forming the negative electrode mixture layer 26 by applying the negative electrode mixture paste to the negative electrode substrate 25, drying the applied negative electrode mixture paste, and pressing the dried negative electrode mixture paste to an appropriate thickness. The negative electrode plate 24 is manufactured through these steps. Steps S1 and S2 may be performed in any order. For example, step S1 may be performed after step S2. Alternatively, steps S1 and S2 may be performed in parallel.

In step S3, the electrode body 20 is manufactured from the positive electrode plate 21, the negative electrode plate 24, and the separators 27. In step S3, the positive electrode plate 21, the negative electrode plate 24, and the separators 27 are stacked and rolled. Further, the roll is pressed and flattened. Then, the positive electrode uncoated portion 22A is press-bonded to form the positive electrode current collector portion 20A. Further, the negative electrode uncoated portion 25A is press-bonded to form the negative electrode current collector portion 20B. The electrode body 20 is manufactured through these steps.

In step S4, the electrode body 20 is accommodated in the case 11 and the non-aqueous electrolyte solution is injected into the case 11. In step S4, the positive electrode current collector portion 20A is connected by the positive electrode current collector member 14A to the positive electrode external terminal 13A. Further, the negative electrode current collector portion 20B is connected by the negative electrode current collector member 14B to the negative electrode external terminal 13B. The open upper end of the case 11 is closed by the lid 12. The electrode body 20 accommodated in the case 11 is dried, and then the non-aqueous electrolyte solution is injected into the case 11. Preferably, the injected non-aqueous electrolyte solution has a temperature in a range of 10° C. to 20° C., inclusive. Subsequently, the lithium-ion rechargeable battery 10 undergoes an aging process and an initial charging process. This manufactures the lithium-ion rechargeable battery 10.

### Operation of Present Embodiment

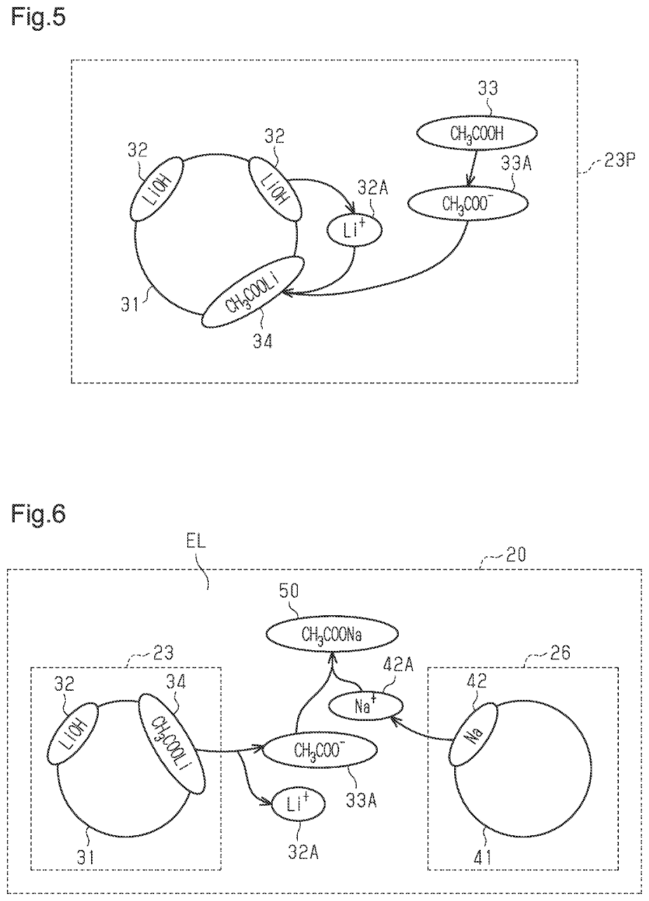

The operation of the present embodiment will now be described with reference to FIGS. 5 to 7.

### Reaction in Positive Electrode Mixture Paste

FIG. 5 schematically shows a state of a positive electrode mixture paste 23P during kneading in step S1. The positive electrode active material 31 and an acetic acid 33, which is an example of an organic acid, are added to the positive electrode mixture paste 23P as raw materials. The positive electrode active material 31 includes a lithium hydroxide 32, which is excess lithium.

In the positive electrode mixture paste 23P, the lithium hydroxide 32 is partly neutralized by the acetic acid 33 and forms a lithium acetate 34, which is an example of the first organic acid salt. Specifically, in the positive electrode mixture paste 23P, lithium ions 32A, ionized from the lithium hydroxide 32, react with acetic acid ions, 33A ionized from the acetic acid 33, to form the lithium acetate 34. The lithium acetate 34 is a salt formed from the lithium ions 32A and the acetic acid ions 33A. The acetic acid ions 33A are examples of the organic acid ions that form the lithium acetate 34.

When the content rate of lithium hydroxide 32 in the positive electrode mixture paste 23P is overly high, gelation of the positive electrode mixture paste 23P is likely to occur. When the content ratio of acetic acid 33 in the positive electrode mixture paste 23P is overly high, the thixotropy of the positive electrode mixture paste 23P is lost thereby causing the components of the positive electrode mixture paste 23P to precipitate easily. In such case, the bonding between the positive electrode mixture layer 23 and the positive electrode plate 21 may become deficient. Thus, the amount of the acetic acid 33 added to the positive electrode mixture paste 23P needs to be controlled to avoid both gelation of the positive electrode mixture paste 23P and precipitation of the components in the positive electrode mixture paste 23P in a state in which the lithium hydroxide 32 is partly neutralized by the acetic acid 33.

The mole number of lithium hydroxide 32 added to the positive electrode mixture paste 23P in the positive electrode plate manufacturing step of step S1 is represented by “A” mol. Further, the mole number of lithium acetate 34 formed in the positive electrode mixture layer 23 is represented by “B” mol. The lithium acetate 34 is formed in the positive electrode mixture layer 23 as a result of the reaction of the lithium ions 32A, ionized from the lithium hydroxide 32, and the acetic acid ions 33A, ionized from the acetic acid 33. In this case, the amount of added acetic acid 33 is determined so that 0.04≤B/A≤0.06 is satisfied.

When 0.04≤B/A is satisfied, gelation of the positive electrode mixture paste 23P resulting from an overly high content ratio of the lithium hydroxide 32 is avoided. Further, when B/A≤0.06 is satisfied, precipitation of the components in the positive electrode mixture paste 23P resulting from an overly low content rate of the lithium hydroxide 32 is avoided. In this manner, when 0.04≤B/A≤0.06 is satisfied, both gelation of the positive electrode mixture paste 23P and precipitation of the components in the positive electrode mixture paste 23P are avoided even in a state in which the lithium hydroxide 32 is partly neutralized by the acetic acid 33.

### Reaction Immediately After Injection of Non-Aqueous Electrolyte Solution

FIG. 6 schematically shows a state of the electrode body 20, impregnated with a non-aqueous electrolyte solution EL, immediately after the non-aqueous electrolyte solution EL is injected into the case 11 in step S4. The BOB ions ionized from LiBOB in the non-aqueous electrolyte solution EL have a lower ion-diffusion rate than the other components in the non-aqueous electrolyte solution EL. Thus, immediately after the non-aqueous electrolyte solution EL is added, the electrode body 20 is impregnated with the components in the non-aqueous electrolyte solution EL except for the BOB ions. In the electrode body 20 before the non-aqueous electrolyte solution EL is injected, the positive electrode mixture layer 23 includes the positive electrode active material 31, the lithium hydroxide 32, and the lithium acetate 34. Further, in the electrode body 20 before the non-aqueous electrolyte solution EL is injected, the negative electrode mixture layer 26 includes a negative electrode active material 41 and a sodium salt 42.

When the electrode body 20 is impregnated with the non-aqueous electrolyte solution EL, the lithium acetate 34 in the positive electrode mixture layer 23 is ionized into the lithium ions 32A and the acetic acid ions 33A. Further, the sodium salt 42 in the negative electrode mixture layer 26 is ionized into sodium ions 42A. Then, the acetic acid ions 33A react with the sodium ions 42A and form sodium acetate 50. The sodium acetate 50 is a salt formed from the acetic acid ions 33A and the sodium ions 42A. The sodium acetate 50 is a salt that includes organic acid ions of the same type as the acetic acid ions 33A forming the lithium acetate 34.

Since the lithium acetate 34 has a higher solubility in the non-aqueous electrolyte solution EL than the sodium acetate 50, the sodium acetate 50 deposits more easily than the lithium acetate 34. As a result, the number of sodium ions 42A in the non-aqueous electrolyte solution EL becomes small.

### State After BOB Ions Reach Electrode Body 20

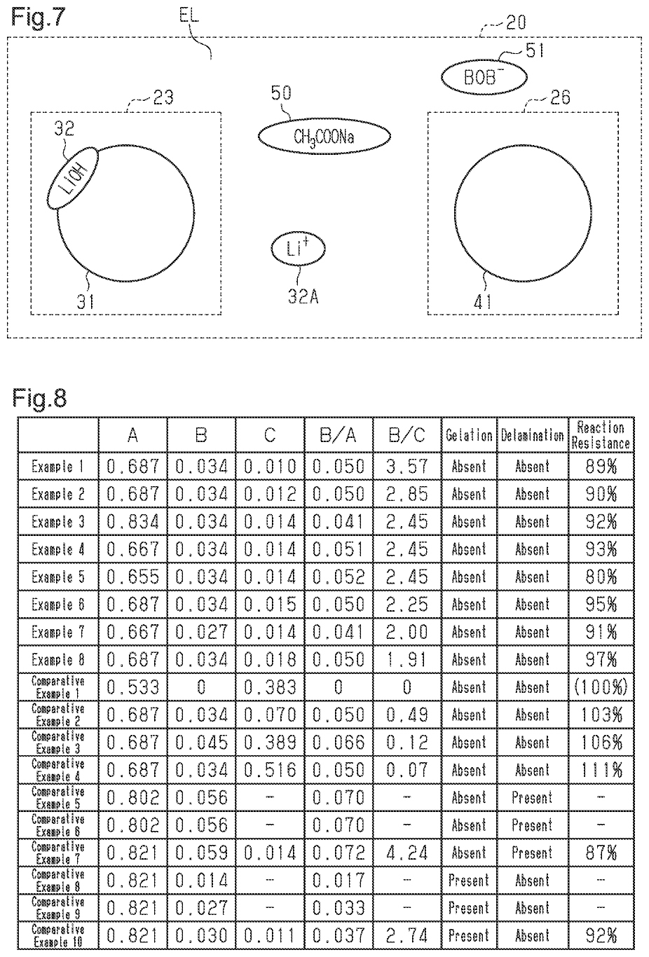

FIG. 7 schematically shows a state of the components after injection of the non-aqueous electrolyte solution EL into the case 11 and when BOB ions 51 in the non-aqueous electrolyte solution EL reach the electrode body 20 later than the other components in the non-aqueous electrolyte solution EL in step S4. As described above, when the BOB ions 51 in the non-aqueous electrolyte solution EL reach the electrode body 20 later than the other components in the non-aqueous electrolyte solution EL, the sodium salt 42 in the negative electrode mixture layer 26 has been deposited as the sodium acetate 50. Thus, the number of sodium ions 42A in the non-aqueous electrolyte solution EL is small This limits formation of a NaBOB film resulting from the reaction of the sodium ions 42A and the BOB ions 51.

The mole number of sodium salt 42 added to the negative electrode mixture paste in the negative electrode plate manufacturing step of step S2 is represented by “C” mol. In this case, the amount of added acetic acid 33 is determined so that a ratio of the mole number of lithium acetate 34 formed in the positive electrode mixture paste 23P to the mole number of sodium salt 42 added to the negative electrode mixture paste, or value B/C, satisfies 1.9≤B/C. Therefore, the amount of acetic acid 33 added to the positive electrode mixture paste 23P is determined so that values A, B, and C satisfy 0.04≤B/A≤0.06 and 1.9≤B/C. When 1.9≤B/C is satisfied, an increase in the resistance resulting from formation of NaBOB is restricted.

In the liquid-injection step of step S4, the temperature of non-aqueous electrolyte solution EL injected into the case 11 is set to be lower than or equal to 20° C. This further reduces the solubility of sodium acetate 50 in the non-aqueous electrolyte solution EL, which in turn, facilitates deposition of the sodium acetate 50. As a result, the concentration of sodium ions 42A in the non-aqueous electrolyte solution EL is further lowered, and formation of a NaBOB film is limited. When the temperature of the non-aqueous electrolyte solution EL injected into the case 11 is set to be higher than or equal to 10° C., an excessive decrease in the fluidity of the non-aqueous electrolyte solution EL is avoided. This avoids uneven impregnation of the electrode body 20 with the non-aqueous electrolyte solution EL.

If ethylene carbonate is used as the only non-aqueous solvent, and the temperature of the non-aqueous electrolyte solution EL is set in a range of 10° C. to 20° C., inclusive, the fluidity of the non-aqueous electrolyte solution EL may become overly low because ethylene carbonate has a high melting temperature. In this regard, the non-aqueous electrolyte solution EL uses a mixture of ethylene carbonate, dimethyl carbonate, and ethyl methyl carbonate as non-aqueous solvents to maintain an appropriate fluidity of the non-aqueous electrolyte solution EL even when the temperature of the non-aqueous electrolyte solution EL is set in a range of 10° C. to 20° C., inclusive.

### Values A, B, and C

The value of “A” (mol), which is the mole number of lithium hydroxide 32 added to the positive electrode mixture paste 23P, will now be described in detail. Value A may be measured by performing titration, such as a Winkler method, on the lithium hydroxide 32 in the positive electrode active material 31 to be used as a raw material.

In the positive electrode mixture layer 23 formed in the positive electrode plate manufacturing step of step Si, the lithium hydroxide 32 added to the positive electrode mixture paste 23P has been partly neutralized by the acetic acid 33. Thus, value A corresponds to the sum of the mole number of lithium hydroxide 32 that is not neutralized by the acetic acid 33 and the mole number of lithium hydroxide 32 that is neutralized by the acetic acid 33 in the lithium hydroxide 32 added to the positive electrode mixture paste 23P. In other words, value A corresponds to the sum of the mole number of lithium hydroxide 32 in the positive electrode mixture layer 23 and the mole number of lithium acetate 34. The lithium acetate 34 is the organic acid component in the positive electrode mixture layer 23, which is formed in the positive electrode plate manufacturing step of step S1.

Value A in the lithium-ion rechargeable battery 10 corresponds to the sum of the mole number of lithium hydroxide 32 included in the positive electrode mixture layer 23 and the mole number of organic acid component included in the lithium-ion rechargeable battery 10. The organic acid component in the lithium-ion rechargeable battery 10 includes the sodium acetate 50 and at least one of the acetic acid ions 33A and the lithium acetate 34. Specifically, in the lithium-ion rechargeable battery 10, all of the lithium acetate 34 in the positive electrode mixture layer 23, which is formed in the positive electrode plate manufacturing step, may be dissolved in the non-aqueous electrolyte solution EL. Alternatively, in the lithium-ion rechargeable battery 10, part of the lithium acetate 34 may be present in the positive electrode mixture layer 23 without being dissolved. Further, all of the acetic acid ions 33A ionized from the lithium acetate 34 may deposit as the sodium acetate 50. Alternatively, the acetic acid ions 33A may be present in the non-aqueous electrolyte solution EL.

In the lithium-ion rechargeable battery 10, value A may be obtained by separately measuring the mole number of lithium hydroxide 32 in the positive electrode mixture layer 23 and the mole number of organic acid component. For example, the mole number of lithium hydroxide 32 in the positive electrode mixture layer 23 in the lithium-ion rechargeable battery 10 may be measured by performing titration, such as a Winkler method. Further, the mole number of organic acid component in the lithium-ion rechargeable battery 10 may be measured by increasing the temperature of the non-aqueous electrolyte solution EL to dissolve all of the organic acid component in the non-aqueous electrolyte solution EL, and then performing titration such as a Winkler method.

The value of “B” (mol), which is the mole number of lithium acetate 34 formed in the positive electrode mixture layer 23 in the positive electrode plate manufacturing step of step S1, will now be described in detail. Value B corresponds to a ratio of the mole number of acetic acid ions 33A that neutralize the lithium hydroxide 32 included in the positive electrode mixture paste 23P. For example, when the acetic acid 33 is used as the organic acid, 1 mol of the acetic acid 33 is ionized into 1 mol of the acetic acid ions 33A. Thus, the mole number “B” of the lithium acetate 34 formed in the positive electrode mixture layer 23 in the positive electrode plate manufacturing step is equal to the mole number of acetic acid 33 added to the positive electrode mixture paste 23P. For example, when acetic anhydride is used as the organic acid, 1 mol of acetic anhydride is ionized into 2 mol of the acetic acid ions 33A. Thus, the mole number “B” of the lithium acetate 34 formed in the positive electrode mixture layer 23 in the positive electrode plate manufacturing step is two times greater than the mole number of the acetic anhydride added to the positive electrode mixture paste 23P. In this manner, value B can be obtained from the amount (mole number) of the organic acid added to the positive electrode mixture paste 23P.

Value B in the lithium-ion rechargeable battery 10 corresponds to the mole number of organic acid component included in the lithium-ion rechargeable battery 10. Accordingly, value A in the lithium-ion rechargeable battery 10 corresponds to the sum of value B and the mole number of lithium hydroxide 32 included in the positive electrode mixture layer 23. As described above, value B in the lithium-ion rechargeable battery 10 may be measured by increasing the temperature of the non-aqueous electrolyte solution EL to dissolve all of the organic acid component in the non-aqueous electrolyte solution EL, and then performing titration such as a Winkler method.

The value of “C” (mol), which is the mole number of sodium salt 42 added to the negative electrode mixture paste in step S2, will now be described in detail. Value of C may be measured, for example, by performing inductively coupled plasma (ICP) optical emission spectrometry on a sample cut out from the negative electrode mixture layer 26.

Value C in the lithium-ion rechargeable battery 10 corresponds to the mole number of sodium component included in the lithium-ion rechargeable battery 10. The sodium component in the lithium-ion rechargeable battery 10 corresponds to at least the sodium acetate 50. The lithium-ion rechargeable battery 10 may further include, as the sodium component, at least one of the sodium salt 42 and the sodium ions 42A. In other words, the sodium component in the lithium-ion rechargeable battery 10 is the sodium acetate 50 or a combination of the sodium acetate 50 and at least one of the sodium salt 42 and the sodium ions 42A. Specifically, all of the sodium salt 42 added to the negative electrode mixture paste in the negative electrode plate manufacturing step may be dissolved in the non-aqueous electrolyte solution EL, and all of the sodium ions 42A ionized from the sodium salt 42 may deposit as the sodium acetate 50. Alternatively, some of the sodium ions 42A ionized from the sodium salt 42 may be present in the non-aqueous electrolyte solution EL, and part of the sodium salt 42 may be present in the negative electrode mixture layer 26 without being dissolved.

Value of C in the lithium-ion rechargeable battery 10 may be measured by increasing the temperature of the non-aqueous electrolyte solution EL to dissolve all of the sodium components in the non-aqueous electrolyte solution EL, and then performing inductively coupled plasma (ICP) optical emission spectrometry.

### Advantages of the Embodiment

The above embodiment has the following advantages.

(1) The acetic acid 33 is added to the positive electrode mixture paste 23P so that the lithium acetate 34 is formed in the positive electrode mixture layer 23. When the non-aqueous electrolyte solution EL is injected in such state, the sodium acetate 50 is formed by reaction of the sodium ions 42A, ionized from the sodium salt 42 in the negative electrode mixture layer 26, and the acetic acid ions 33A, ionized from the lithium acetate 34. In this case, since the lithium acetate 34 has a higher solubility in the non-aqueous electrolyte solution EL than the sodium acetate 50, the sodium acetate 50 deposits more easily than the lithium acetate 34. As a result, when the BOB ions 51 impregnate the electrode body 20 later than the other components in the non-aqueous electrolyte solution EL, the number of sodium ions 42A in the non-aqueous electrolyte solution EL is small. This limits formation of a NaBOB film caused by the reaction of the sodium ions 42A and the BOB ions 51.

(2) The value B/C satisfies 1.9≤B/C so that the number of sodium ions 42A in the non-aqueous electrolyte solution EL is appropriately decreased. This restricts an increase in the resistance resulting from formation of a NaBOB film.

(3) The value B/A satisfies 0.04≤B/A≤0.06 so that both gelation of the positive electrode mixture paste 23P and precipitation of the components in the positive electrode mixture paste 23P are avoided even in a state in which the lithium hydroxide 32 is partly neutralized by the acetic acid 33.

(4) When the acetic acid 33 is used as the organic acid, the first organic acid salt is the lithium acetate 34, and the second organic acid salt is the sodium acetate 50. In this case, the first organic acid salt has a higher solubility in the non-aqueous electrolyte solution EL than the second organic acid salt. The same applies to when acetic anhydride is used as the organic acid.

(5) The temperature of the non-aqueous electrolyte solution EL injected into the case 11 is set to be lower than or equal to 20° C. to facilitate deposition of the sodium acetate 50. This limits formation of a NaBOB film. Further, the temperature of the non-aqueous electrolyte solution EL injected into the case 11 is set to be higher than or equal to 10° C. to avoid an excessive decrease in the fluidity of the non-aqueous electrolyte solution EL. This avoids uneven impregnation of the electrode body 20 with the non-aqueous electrolyte solution EL.

(6) The non-aqueous electrolyte solution EL uses ethylene carbonate, dimethyl carbonate, and ethyl methyl carbonate as non-aqueous solvents to maintain an appropriate fluidity of the non-aqueous electrolyte solution EL even when the temperature of the non-aqueous electrolyte solution EL is set in a range of 10° C. to 20° C., inclusive.

### MODIFIED EXAMPLES

The above embodiment may be modified as described below. The following modifications can be combined as long as the combined modifications remain technically consistent with each other.

The non-aqueous electrolyte solution EL may have any type of solvent as long as the fluidity of the non-aqueous electrolyte solution EL is appropriate when the temperature of the non-aqueous electrolyte solution EL is set in a range of 10° C. to 20° C., inclusive. For example, the non-aqueous electrolyte solution EL may have any of the non-aqueous solvents described in the above embodiment. Further, even when the non-aqueous electrolyte solution EL uses ethylene carbonate, dimethyl carbonate, and ethyl methyl carbonate as non-aqueous solvents, the mass ratio is not limited to 1:1:1. In this case, the mass ratio of the non-aqueous solvents may only be determined such that the non-aqueous electrolyte solution EL has an appropriate fluidity when the temperature of the non-aqueous electrolyte solution EL is set in a range of 10° C. to 20° C., inclusive.

The temperature of the non-aqueous electrolyte solution EL injected into the case 11 may be changed in accordance with the type of the non-aqueous solvent. For example, the temperature of the non-aqueous electrolyte solution EL may be higher than 20° C. as long as deposition of the sodium acetate 50 is sufficient. For example, the temperature of the non-aqueous electrolyte solution EL may be lower than 10° C. as long as the fluidity of the non-aqueous electrolyte solution EL is appropriate.

In the above-described example, the acetic acid 33 or acetic anhydride is used as the organic acid. However, there is no limitation to the type of organic acid. The organic acid may be any type of organic acid as long as the first organic acid salt, formed from lithium and the organic acid, has a higher solubility in the non-aqueous electrolyte solution EL than the second organic acid salt, formed from sodium and the organic acid. For example, the organic acid may be citric acid. Alternatively, the organic acid may be a combination of citric acid and either one of the acetic acid 33 and acetic anhydride. For example, the organic acid is one selected from a group consisting of the acetic acid 33, acetic anhydride, and citric acid.

The lithium-ion rechargeable battery 10 may be used in an automatic transporting vehicle, a special hauling vehicle, a battery electric vehicle, a hybrid electric vehicle, a computer, an electronic device, or any other system. For example, the lithium-ion rechargeable battery 10 may be used in a marine vessel, an aircraft, or any other type of movable body. The lithium-ion rechargeable battery 10 may also be used in a system that supplies electric power from a power plant via a substation to buildings and households.

### Examples

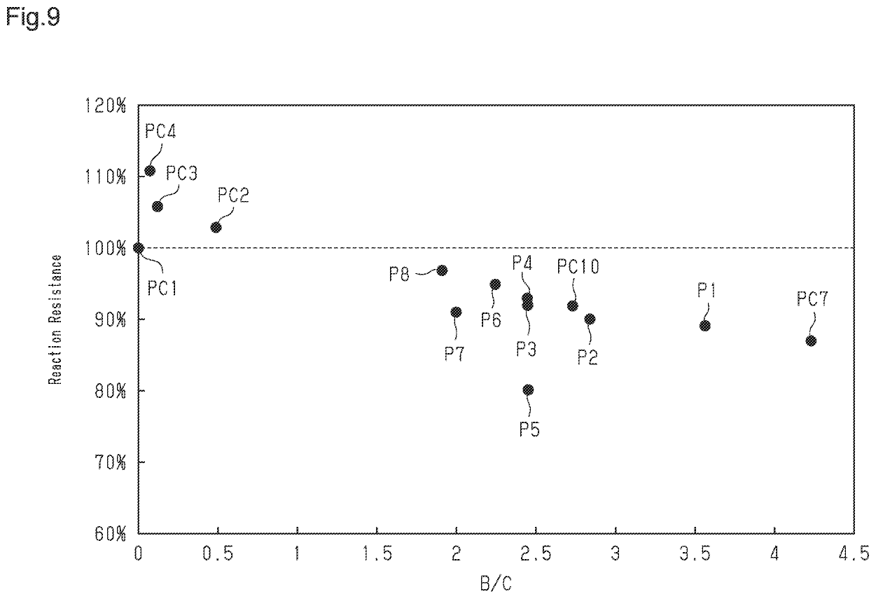

Examples 1 to 8 and Comparative Examples 1 to 10 will now be described with reference to FIGS. 8 and 9. Following examples are to illustrate the advantages of the above embodiment and not to limit the scope of the present disclosure.

### Preparation of Samples

In Examples 1 to 8 and Comparative Examples 1 to 10, steps S1 to S4 were performed to manufacture a lithium-ion rechargeable battery 10, and the lithium-ion rechargeable battery 10 underwent an aging process and initial charging. The acetic acid 33 was used as the organic acid. The concentration of LiBOB in the non-aqueous electrolyte solution EL was 0.003 mol/L. In Comparative Example 1, the lithium-ion rechargeable battery 10 was prepared without adding the acetic acid 33 to the positive electrode mixture paste 23P. In Comparative Examples 5, 6, 8, and 9, the manufacture of the lithium-ion rechargeable battery 10 was ended when the positive electrode plate 21 was produced in the positive electrode plate manufacturing step of step S1.

In the state of raw material, the mole number of lithium hydroxide 32 per unit weight of the positive electrode active material 31 was measured. Then, value A was calculated based on the weight per unit area of the positive electrode mixture layer 23. Further, value B was obtained from the amount of the added acetic acid 33. Subsequently, part of the negative electrode mixture layer 26, formed in step S2, was cut out from the negative electrode plate 24 to measure the amount of sodium element per unit weight of the negative electrode mixture layer 26. Then, value C was calculated based on the weight per unit area of the negative electrode mixture layer 26. FIG. 8 shows values A, B, C, B/A, and B/C in Examples 1 to 8 and Comparative Examples 1 to 10.

### Example 1

As shown in FIG. 8, in Example 1, value A was 0.687 mol, value B was 0.034 mol, value C was 0.010 mol, value B/A was 0.050, and value B/C was 3.57.

### Example 2

In Example 2, value A was 0.687 mol, value B was 0.034 mol, value C was 0.012 mol, value B/A was 0.050, and value B/C was 2.85.

### Example 3

In Example 3, value A was 0.834 mol, value B was 0.034 mol, value C was 0.014 mol, and value B/A was 0.041, and value B/C was 2.45.

### Example 4

In Example 4, value A was 0.667 mol, value B was 0.034 mol, value C was 0.014 mol, value B/A was 0.051, and value B/C was 2.45.

### Example 5

In Example 5, value A was 0.655 mol, value B was 0.034 mol, value C was 0.014 mol, value B/A was 0.052, and value B/C was 2.45.

### Example 6

In Example 6, value A was 0.687 mol, value B was 0.034 mol, value C was 0.015 mol, value B/A was 0.050, and value B/C was 2.25.

### Example 7

In Example 7, value A was 0.667 mol, value B was 0.027 mol, value C was 0.014 mol, value B/A was 0.041, and value B/C was 2.00.

### Example 8

In Example 8, value A was 0.687 mol, value B was 0.034 mol, value C was 0.018 mol, value B/A was 0.050, and value B/C was 1.91.

### Comparative Example 1

In Comparative Example 1, value A was 0.533 mol and value C was 0.383 mol. Since the acetic acid 33 was not added in Comparative Example 1, values B, B/A, and B/C were each 0 mol.

### Comparative Example 2

In Comparative Example 2, value A was 0.687 mol, value B was 0.034 mol, value C was 0.070 mol, value B/A was 0.050, and value B/C was 0.49.

### Comparative Example 3

In Comparative Example 3, value A was 0.687 mol, value B was 0.045 mol, value C was 0.389 mol, value B/A was 0.066, and value B/C was 0.12.

### Comparative Example 4

In Comparative Example 4, value A was 0.687 mol, value B was 0.034 mol, value C was 0.516 mol, value B/A was 0.050, and value B/C was 0.07.

### Comparative Examples 5 and 6

In Comparative Examples 5 and 6, value A was 0.802 mol, value B was 0.056 mol, and value B/A was 0.070. Comparative Examples 5 and 6 were different samples having the same values.

### Comparative Example 7

In Comparative Example 7, value A was 0.821 mol, value B was 0.059 mol, value C was 0.014 mol, value B/A was 0.072, and value B/C was 4.24.

### Comparative Example 8

In Comparative Example 8, value A was 0.821 mol, value B was 0.014 mol, and value B/A was 0.017.

### Comparative Example 9

In Comparative Example 9, value A was 0.821 mol, value B was 0.027 mol, and value B/A was 0.033.

### Comparative Example 10

In Comparative Example 10, value A was 0.821 mol, value B was 0.030 mol, value C was 0.011 mol, value B/A was 0.037, and value B/C was 2.74.

### Evaluations

It was determined whether gelation of the positive electrode mixture paste 23P occurred during the manufacturing process of the lithium-ion rechargeable battery 10. Further, it was determined whether the positive electrode mixture layer 23 delaminated from the positive electrode substrate 22 in the positive electrode plate 21 during the manufacturing process of the lithium-ion rechargeable battery 10. The lithium-ion rechargeable batteries 10 in Examples and Comparative Examples that underwent initial charging were measured for reaction resistance. Then, the reaction resistance was compared to that of Comparative Example 1, in which the acetic acid 33 was not added, to obtain a ratio of the reaction resistance of each of the Examples and the Comparative Examples to that of Comparative Example 1. FIG. 8 shows the evaluation results. FIG. 9 shows the relationship of value B/C and the reaction resistance ratio of each Example and Comparative Example to Comparative Example 1.

### Gelation of Positive Electrode Mixture Paste and Delamination of Positive Electrode Mixture Layer

As shown in FIG. 8, in Examples 1 to 8 and Comparative Examples 1 to 7, gelation of the positive electrode mixture paste 23P was not detected. In contrast, in Comparative Examples 8 to 10, in which value B/A was less than 0.04, gelation of the positive electrode mixture paste 23P was detected.

In Examples 1 to 8, Comparative Examples 1 to 4, and Comparative Examples 8 to 10, delamination of the positive electrode mixture layer 23 from the positive electrode plate 21 was not detected. In contrast, in Comparative Examples 5 to 7, in which value B/A was 0.07 or greater, delamination of the positive electrode mixture layer 23 from the positive electrode plate 21 was detected.

These results indicate that when 0.04≤B/A≤0.06 is satisfied, both gelation of the positive electrode mixture paste 23P and precipitation of the components in the positive electrode mixture paste 23P are avoided even in a state in which the lithium hydroxide 32 is partly neutralized by the acetic acid 33.

### Reaction Resistance

In the graph shown in FIG. 9, the horizontal axis indicates value B/C, and the vertical axis indicates the ratio of the reaction resistance of each Example and Comparative Example to the reference of Comparative Example 1. Points P1 to P8 in the graph correspond to the results of Examples 1 to 8, respectively. Points PC1 to PC4 in the graph correspond to the results of Comparative Examples 1 to 4, respectively. Point PC7 in the graph corresponds to the result of Comparative Example 7. Point PC10 in the graph corresponds to the result of Comparative Example 10.

As shown in FIG. 9, in Examples 1 to 8, in which value B/C was greater than or equal to 1.9, the reaction resistance was lower than that of Comparative Example 1. There was a tendency that the reaction resistance further decreased as value B/C increased. Also, in Comparative Examples 7 and 10, in which value B/C was greater than or equal to 1.9, the reaction resistance was lower than that of Comparative Example 1.

In contrast, in Comparative Examples 2 to 4, in which value B/C was less than 1.9, the reaction resistance was greater than that of Comparative Example 1. These results indicate that when value B/C is set to 1.9 or greater, an increase in the resistance resulting from formation of a NaBOB film is restricted.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method for manufacturing a lithium-ion rechargeable battery, the method comprising:
manufacturing a positive electrode plate by forming a positive electrode mixture layer on a positive electrode substrate, the positive electrode mixture layer using a positive electrode mixture paste as a precursor, and an organic acid and a positive electrode active material including lithium hydroxide being added to the positive electrode mixture paste;
manufacturing a negative electrode plate by forming a negative electrode mixture layer on a negative electrode substrate, the negative electrode mixture layer using a negative electrode mixture layer as a precursor, and a sodium salt being added to the negative electrode mixture paste; and
injecting a non-aqueous electrolyte solution including LiBOB into a case that accommodates an electrode body including the positive electrode plate and the negative electrode plate, wherein:
the manufacturing the positive electrode plate includes forming a first organic acid salt in the positive electrode mixture layer, the first organic acid salt being formed from lithium ions derived from the lithium hydroxide and organic acid ions derived from the organic acid;
when “A” represents a mole number of the lithium hydroxide added in the manufacturing the positive electrode plate, “B” represents a mole number of the first organic acid salt formed in the manufacturing the positive electrode plate, and “C” represents a mole number of the sodium salt added in the manufacturing the negative electrode plate, values A, B, and C satisfy 0.04≤B/A≤0.06 and 1.9≤B/C; and
the first organic acid salt has a higher solubility in the non-aqueous electrolyte solution than a second organic acid salt, formed from sodium ions and organic acid ions of the same type as that forming the first organic acid salt.

2. The method according to claim 1, wherein the organic acid is acetic acid or acetic anhydride.

3. The method according to claim 1, wherein the injecting the non-aqueous electrolyte solution includes injecting the non-aqueous electrolyte solution set in a range of 10° C. to 20° C., inclusive.

4. The method according to claim 3, wherein the non-aqueous electrolyte solution includes ethylene carbonate, dimethyl carbonate, and ethyl methyl carbonate.

5. A lithium-ion rechargeable battery, the battery comprising:
an electrode body including a positive electrode plate and a negative electrode plate;
a non-aqueous electrolyte solution including LiBOB;
lithium hydroxide included in the positive electrode plate;
an organic acid component; and
a sodium component, wherein
the organic acid component includes:
at least one of a first organic acid salt, formed from organic acid ions and sodium ions, and organic acid ions ionized from the first organic acid salt, and
a second organic acid formed from sodium ions and organic acid ions ionized from the first organic acid salt;
the sodium component includes:
the second organic acid salt, or
a combination of the second organic acid salt and at least one of sodium salt included in the negative electrode plate, and sodium ions ionized from the sodium salt;
when “A” represents a sum of a mole number of the lithium hydroxide and a mole number of the organic acid component, “B” represents a mole number of the organic acid component, and “C” represents a mole number of the sodium component, values A, B, and C satisfy 0.04≤B/A≤0.06 and 1.9≤B/C; and
the first organic acid salt has a higher solubility in the non-aqueous electrolyte solution than the second organic acid salt.
